(19) United States
(12) Patent Application Publication
(10) Pub. No.: US 2025/0216224 A1
(43) Pub. Date: Jul. 3, 2025

(54) MODULE FOR ANALOG MEASUREMENT VALUE LOGGING

(71) Applicant: Turck Holding GmbH, Halver (DE)

(72) Inventors: Tobias Danzig, Oberhausen (DE); Andreas Hödl, Mülheim (DE)

(73) Assignee: Turck Holding GmbH, Halver (DE)

(21) Appl. No.: 19/085,002

(22) Filed: Mar. 20, 2025

Related U.S. Application Data
(63) Continuation of application No. PCT/EP2023/073315, filed on Aug. 24, 2023.

(30) Foreign Application Priority Data
Sep. 27, 2022 (LU) LU502845

(51) Int. Cl. G01D 9/00; G01K 1/02

(52) U.S. Cl. CPC G01D 9/005; G01K 1/026

(57) ABSTRACT

A module for analog measurement value logging comprises two ports, wherein, for each port, a measuring transducer, optionally a temperature sensor, can be connected to the module for analog measurement value logging; and a memory, optionally a non-volatile memory. In the memory, for each of the two ports, a dedicated memory area is provided which is permanently assigned to the associated port.

### CROSS REFERENCE TO RELATED APPLICATIONS

This application is a continuation application of international patent application PCT/EP2023/073315, filed on Aug. 24, 2023, and designating the U.S., which claims priority to Luxembourg patent application LU502845, filed on Sep. 27, 2022, all of which are hereby incorporated by reference in their entireties.

### TECHNICAL FIELD

The present disclosure relates to a module for analog measurement value logging and a system for data processing with the module for analog measurement value logging, a method for operating a module for analog measurement value logging, a computer program for a module for analog measurement value logging, a computer-readable medium having the computer program, a method for writing a specification for processing information in a memory of a module for analog measurement value logging, a method for determining a file with a predefined internal structure for processing a measurement variable which can be received from a measurement transducer on a module for analog measurement value logging, a device for data processing, which comprises means for carrying out a method for operating a module for analog measurement value logging, a computer program for operating a module for analog measurement value logging, a computer-readable medium having the computer program, a file for use in a module for analog measurement value logging, and/or a computer-readable medium having the file.

### BACKGROUND

The discussion of the prior art in the description is in no way intended to be regarded as an admission that this prior art is generally known or belongs to the general knowledge in the field.

U.S. Pat. No. 4,403,296 A describes an electronic measuring device that uses multiple different transducers to provide signals that have predetermined and typically nonlinear relationships to multiple input variables that are captured by the transducers. The measuring device contains a microcomputer that stores linearization information related to the predetermined nonlinear relationship between the signals supplied by the transducers and the variables captured by the measurement transducers. The microcomputer linearizes each of the signals supplied by the transducers, thus obtaining highly accurate signals that indicate the captured variables. Depending on the final determination to be achieved by the device, the linearized signals, which are representative of the input variables, can be used in a polynomial equation calculation performed by the computer to obtain the output determination. The polynomial equation contains a large number of constants, and different values of the constants are stored in memory for different segments of the curve defined by the polynomial equation. The values of the constants also represent stored linearization information, and the various values are available for use in the calculation to obtain the best accuracy when simulating the mathematical curve of the polynomial equation with the actual curve of the variable to be determined.

EP 0 692 160 B1 relates to an integrating analog/digital converter for converting an analog signal into a digital representation, having: a circuit responding to the analog signal for delivering a first output signal which changes at least between first and second levels and has a frequency characteristic as a function of the integral of the analog signal; at least one first counter responding to the first output signal for counting the signal level changes and delivering a first counter output signal representing the count; a first temperature measuring device which provides a circuit temperature output signal representative of the temperature of a selected ambient temperature region near to the circuit; and a memory for storing first information describing the temperature characteristic of the circuit, so that the first counter can be corrected as a function of the circuit temperature output signal and said information.

US 2005/0033540 A1 relates to a sensor arrangement. The sensor arrangement comprises a transducer, a memory element for storing a plurality of transducer signatures and a processor for identifying the transducer using the transducer signatures, for processing the environmental features using the identified transducer signatures and the adaptive algorithm, and for outputting the processed environmental features.

US 2019/0095381 A1 relates to an electronic device comprising a communication device and a processor. The processor receives sensor type information via the communication device from at least one sensor or an electronic measuring instrument to which the at least one sensor is connected, transmits the received sensor type information to a database which stores a combination of a sensor type and a measurement mode in which measurement contents are defined, identifies the measurement mode from the database in accordance with the transmitted sensor type information and sets the identified measurement mode in corresponding to the at least one sensor or the at least one sensor connected to the electronic measurement instrument.

### SUMMARY

A module for analog measurement value logging is provided, wherein the module for analog measurement value logging comprises two ports, wherein for each port a measurement transducer can be connected to the module for analog measurement value logging, and a memory, wherein the memory comprises a dedicated memory area for each of the two ports, which is permanently assigned to the respective port.

A method for operating a module for analog measurement value logging is provided, wherein the module for analog measurement value logging includes two ports, wherein for each port a measurement transducer can be connected to the module for analog measurement value logging, and a memory, wherein the method comprises receiving information from one of the measurement transducers via one of the two ports, determining via which of the two ports the information was received, and accessing a dedicated memory area of the memory, which is permanently assigned to the port via which the information was received.

### BRIEF DESCRIPTION OF THE DRAWINGS

In the drawings:

FIG. 1 schematically shows a system for data processing having a module for analog measurement value logging in a measurement mode,

FIG. 2 schematically shows the module for analog measurement value logging from FIG. 1 in detail in the measurement mode,

FIG. 3 schematically shows a flowchart of a method for operating the system for data processing from FIG. 1 comprising the module for analog measurement value logging from FIG. 2,

FIG. 4 schematically shows the module for analog measurement value logging from FIG. 1 in detail during writing or placement of the module for analog measurement value logging,

FIG. 5 schematically shows a flowchart of a method for writing a specification to the module for analog measurement value logging from FIG. 4,

FIG. 6 schematically shows a flowchart of a method for determining the specification, and

FIG. 7 schematically shows a graphical user interface for use in the method for determining the specification.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A module for analog measurement value logging may be provided, wherein the module for analog measurement value logging comprises (at least) two ports, wherein for each port one measurement transducer, optionally a temperature sensor and/or a pressure sensor, can be connected to the module for analog measurement value logging, and a memory, optionally a non-volatile memory.

A module for analog measurement value logging can in the present case be understood to mean a data processing device, which is designed to receive information from measurement transducers or sensors via ports provided for this purpose, to process said information and output it, optionally via a gateway, to a (process) control system.

In the memory, a memory area is provided for each of the two ports, which is permanently assigned to the respective port.

In other words, a first memory area can be provided or reserved for one of the two ports and a second memory area, different from the first memory area, can be provided for the other of the two ports. The assignment can be stored, for example, in software, optionally in firmware, of the module for analog measurement value logging, i.e. the software can “know” which memory area is to be assigned to which port. The number of ports is not limited to two and any number of ports and thus any number of memory areas are conceivable.

A port can be understood to mean an (input) channel. Analog and/or digital signals can be received from the module for analog measurement value logging via the port. Each port can have multiple connection terminals, e.g. four.

The information from the measurement transducers can be received, for example, as analog signals at the module for analog measurement value logging, digitized by the module for analog measurement value logging and then these digitized signals can be processed.

The term processing can be understood in the present case to mean that the digitized signals serve as input data for an algorithm that is stored in the module for analog measurement value logging. The algorithm can be, for example, a so-called firmware of the module for analog measurement value logging.

In the case in which the signals correspond to a measurement variable of the measurement transducer, i.e., for example, to a temperature and/or a pressure, the input data can be processed in such a way that the input data are converted into a measurement value, i.e. the temperature and/or the pressure, according to the stored specification.

Traditionally, the specification or calculation rule or formula used for the conversion or processing is stored in the module for analog measurement value logging for various predefined, usually standardized, measurement transducers. This means that a conventional module for analog measurement value logging can only be used to operate predetermined types of measurement transducers.

In addition, the specification with which the conversion or processing is carried out for the various predefined measurement transducers is permanently stored in the firmware of the module for analog measurement value logging. This means that if a measurement transducer, for which the specification is not stored in the firmware, is to be operated with the module for analog measurement value logging, then the firmware must be adapted. This often requires that this adapted firmware be completely re-validated or verified.

In the case of the disclosed module for analog measurement value logging, because the specification is no longer stored in the firmware itself, but in the memory, optionally the flash memory, of the module for analog measurement value logging, this specification can be updated if necessary without changing the firmware. Compared to a conventional firmware, the firmware can thus be extended to include the function of loading a customer-specific specification for processing sensor data in the field. It is conceivable that the gateway connected to the module uses module parameters to determine which data from the module for analog measurement value logging is transmitted via the respective module and, optionally, to the control center.

In other words, if a measurement transducer is to be operated with the analog measurement value logging module, the specification of which is not stored in the analog measurement value logging module, the specification can be written to the memory and can then be used by the unchanged firmware. This makes it possible to adapt the module for analog measurement value logging to new sensor types in the field.

The specification may be stored in a memory area that is permanently assigned to the respective port. This allows the firmware to determine which specification will be used to process the received sensor data or the information received from the measurement transducer, without having to determine the sensor type.

Possible refinements of the module for analog measurement value logging described above are explained in detail below.

The module for analog measurement value logging can be designed to determine via which of the two ports a piece of information, optionally a measurement variable, was received from the measurement transducer that can be connected to the respective port and based thereon, to access the memory area which is permanently assigned to this port.

A specification for processing the received information can be stored in the memory area which is accessed, and the module for analog measurement value logging can be configured to access this specification.

Accessing can be understood, for example, to mean invoking or loading the specification by a piece of software, optionally the firmware, executed by the module for analog measurement value logging.

The module for analog measurement value logging can be designed to process the received information using the specification for processing the received information that was accessed, and thus to generate output information.

The specification can be based on a measurement transducer or sensor characteristic curve or represent it in digital form. In other words, the specification can express the sensor characteristic in formula notation. A sensor characteristic curve can be understood as a relationship between measurement variable and measurement value of a sensor in the form of the so-called characteristic curve. This can mean that with its characteristic curve a sensor describes how a voltage or resistance value is to be calculated as a function of the sensor output variable (in the unit of the actual physical measurement variable, i.e. ° C.) and vice versa within a range defined by a minimum and maximum sensor output variable.

It is conceivable that the specification does not include the function required to describe the sensor characteristic itself, but only or exclusively comprises constants together with a reference to a function stored in the software, optionally firmware, of the module for analog measurement value logging. This means that multiple functions can be stored in the software of the module for analog measurement value logging, wherein the firmware selects one of these functions based on the reference stored in the specification and inserts the constants contained in the specification into the selected function. Only a single constant may conceivably be provided (e.g. the slope of a linear function). This means that multiple constants can be contained in the specification, but a single constant can also be sufficient depending on the function stored in the module for analog measurement value logging.

It is conceivable that the characteristic curve is divided into multiple subranges with different functions. This means that for each of the subranges, a function describing the sensor characteristic in the respective subrange can be invoked in the module for analog measurement value logging. It is also conceivable here that the specification does not include the function required to describe the sensor characteristic itself, but only or exclusively comprises constants for each of the subranges together with a reference to a function stored in the software, optionally firmware, of the module for analog measurement value logging. This means that multiple functions can be stored in the software of the module for analog measurement value logging, wherein the firmware selects one of these functions for the respective subrange based on the reference stored in the specification and inserts the constants for the respective subrange contained in the specification into the selected function.

If a measurement variable is a non-electrical measurement variable (e.g. temperature, pressure, etc.), a sensor is first required that generates a primary electrical signal, e.g. an electrical voltage, correlated with the measurement variable. This primary electrical signal can be output from the sensor to the analog measurement logging module, where it is received at the port connected to the sensor. The primary signal can sometimes be relatively small and can therefore be partially amplified before it is fed into a digitization stage. The digitization converts the electrical primary signal, in analog form, into a corresponding digital signal, which can be further processed digitally by an algorithm of the module for analog measurement value logging, optionally its firmware. Often, the digital signal processing also corrects deficiencies present on the analog side, optionally of characteristic curves that are not ideal. Finally, a measurement value can be output, e.g. a temperature in ° C. and/or a pressure in Pa (pascals).

The module for analog measurement value logging can have an interface and be designed to output the generated output information via the interface to an external data processing device, optionally a gateway, which can be connected to the interface.

The module for analog measurement logging can comprise a microprocessor. The module for analog measurement value logging can be an intelligent processor-controlled unit, which can communicate, e.g. via the interface and a gateway, with other modules (optionally for the analog measurement value logging) and/or a control system.

The interface can be an input/output (I/O) interface, i.e. an interface that can be used both to receive and send information.

The specification can contain or consist of a file, optionally a binary file, which is in a file format with a predefined (internal) structure.

In electronic data processing, the content of each file is primarily a one-dimensional concatenation of bits that are interpreted in groups of byte blocks. The file format defines the syntax (allowed values, formal structure/“grammar”) and semantics (meaning and interpretation) of data within the file. It thus represents a bidirectional mapping of information to a one-dimensional binary memory. Because in the present case a file format or a (computer-implemented) file structure with a predefined structure is used, the file becomes interpretable for a user, in this case, for example, a piece of software executed by the module for analog measurement value logging. A predefined structure can be understood to mean that the file is composed of byte blocks of predetermined size (i.e. with a predetermined number of bytes), which are concatenated in a predefined sequence and each of the byte blocks is assigned a predetermined type of information. One or more of these byte blocks can contain the specification or characteristic curve. The structure of the byte blocks can also be defined.

The module for analog measurement value logging can be configured to process files that are in the file format with the predefined structure.

In other words, the module for analog measurement value logging, optionally the software executed by the module for analog measurement value logging (e.g. the firmware), can “know” which information is stored at which point in the file. Therefore, the module for analog measurement value logging may be able to process sensor data of any arbitrary sensor provided its characteristic curve is stored in the specified file format.

The above description can be summarized in other words and with reference to a concrete embodiment as described below, wherein this following description is given only as an example and is thus not limiting for the disclosure as such: A sensor description comprising a sensor characteristic curve can be stored in a rear part of the flash memory, reserved for non-volatile variables, of the module for analog measurement value logging which is implemented as a temperature input module. Polynomials that describe the characteristic curve of a sensor not previously known to the module for analog measurement value logging can be stored in the same structure as the characteristic curves already stored. In addition to the characteristic curve, the sensor description can have an identification number for the sensor, a string for naming the sensor, (optional parameterizations) and/or a CRC value for verifying a valid sensor description. In the case of four ports for temperature sensors, four identical flash areas can be reserved for the sensor description, each counting for one channel or port. Thus, an individual characteristic curve can be set for each channel and thus for each sensor.

The disclosure further relates to a data processing system, wherein the data processing system comprises a control system, a gateway connected to the control system, and the component described above, which is connected via the gateway to the control system.

A gateway can be understood in the present case to mean a component comprising hardware and software, which establishes a connection, optionally a bidirectional connection, between the module for analog measurement value logging and the (process) control system. The gateway determines an intercompatibility between communication standards. For example, the gateway can communicate with the control system via Ethernet and with the module for analog measurement value logging via a CAN interface using the CANopen protocol, wherein the data received from the respective device is transformed or translated into the respective other communication standard.

The description above with reference to the module for analog measurement value logging also applies mutatis mutandis to the data processing system and vice versa.

The disclosure further relates to a method for operating a module for analog measurement value logging, wherein the module for analog measurement value logging comprises two ports, wherein for each port one measurement transducer, optionally a temperature sensor, can be connected to the module for analog measurement value logging, and a memory, optionally a non-volatile memory.

The method comprises receiving information from one of the measurement transducers via one of the two ports, determining via which of the two ports the information was received, and accessing a memory area of the memory which is permanently assigned to the port via which the information was received.

The method can be a computer-implemented method, i.e. one, multiple or all steps of the method can be carried out at least partially by a computer or a data processing device.

Possible refinements of the method described above are explained in detail below.

A specification for processing the received information can be stored in the memory area that is accessed, and the method can comprise accessing this specification.

The method can comprise processing the received information, using the specification for processing the received information that was accessed, in order to generate output information.

The method can comprise outputting the generated output information via an interface of the module for analog measurement value logging to an external data processing device connected to the interface.

The specification can contain or consist of a (digital) file in a file format with a predefined internal structure.

The specification can be invoked by means of a computer program executed by the module for analog measurement value logging, which is configured to process files that are in the file format with the predefined internal structure.

The above description with reference to the module for analog measurement value logging and the data processing system also applies mutatis mutandis to the method for operating the module for analog measurement value logging and vice versa.

Furthermore, a computer program comprising instructions which, during the execution of the program by the above-described module for analog measurement value logging, cause said program to carry out a method which includes determining via which of the at least two ports information was received and accessing the memory area which is permanently assigned to the port via which the information was received.

A program code of the computer program can be written in any coding language, optionally in a code suitable for controllers of modules for analog measurement value logging (e.g. in a hardware-compatible programming language, such as the C programming language).

A specification for processing the received information can be stored in the memory area that is accessed, and the method can comprise accessing this specification.

The method can comprise processing the received information, using the specification for processing the received information that was accessed, in order to generate output information.

The method can comprise outputting the generated output information via an interface of the module for analog measurement value logging to an external data processing device connected to the interface.

The specification can contain or consist of a file which is in a file format with a predefined internal structure.

The computer program can be configured to process files that are in the file format with the predefined internal structure.

The computer program can be a firmware module for analog measurement value logging. Firmware can be understood as a piece of software that is (permanently) embedded in electronic devices, such as here the module for analog measurement value logging, and performs basic functions there. The firmware can occupy an intermediate position between hardware of the module for analog measurement value logging (i.e. the physical components of the module for analog measurement value logging) and any application software that may be present (the optionally interchangeable programs of the module for analog measurement value logging). The firmware can be stored in the memory of the module for analog measurement value logging. The memory can be a flash memory, EPROM, EEPROM, or a ROM.

The description above with reference to the module for analog measurement value logging, method for operating the module for analog measurement value logging and data processing system also applies mutatis mutandis to the computer program and vice versa.

Furthermore, the disclosure relates to a (non-transitory) computer-readable medium, optionally a computer-readable storage medium, comprising the computer program described above.

The computer-readable medium can be any digital data storage device, such as a USB stick, hard drive, flash memory, a CD-ROM, SD card, or an SSD card.

The computer program does not necessarily have to be stored on such a computer-readable storage medium in order to be made available to the module for analog measurement value logging, but can also be obtained via the Internet or other external means.

The description above with reference to the module for analog measurement value logging, method for operating the module for analog measurement value logging, data processing system and computer program also applies mutatis mutandis to the computer-readable medium and vice versa.

Furthermore, the disclosure relates to a method for writing a specification for processing information to the memory of the module for analog measurement value logging described above.

This method can also be a computer-implemented method.

The method comprises defining the port of the at least two ports of the module for analog measurement value logging to which the specification is to be assigned, and writing the specification to the memory area of the memory of the module for analog measurement value logging that is permanently assigned to this port.

For example, the port can be set using a web server of the gateway. The information about the channel or port to which the specification is to be assigned is then transferred from the gateway to the module for analog measurement value logging when sending the specification. In the case in which the specification is sent after being divided into a plurality of data packets, one or more, optionally all, of the data packets may include this information. If SDO is used (described in detail below), this can mean that each SDO transfer is preceded by a so-called sub-index (=1 byte), which determines which channel or port the data packet is directed to or for which port it is to be used.

In the context of accessing the memory, this is understood to mean a memory access. The way in which the memory is accessed is referred to as the access type. The above accessing of the memory for the purpose of accessing the specification or characteristic curve (data) is a read access. Writing the specification, on the other hand, can also be called a write access.

The method can comprise sending the specification from an external data processing device, optionally a gateway, to an interface of the module for analog measurement value logging, and receiving the specification at the interface of the module for analog measurement value logging. The specification can be sent to the interface in a plurality of data packets, optionally of the same size.

Therefore, a message bus from the gateway to the module for analog measurement value logging may be prevented from being not overloaded.

It is conceivable that the specification is not written to the memory area of the memory until the specification in its entirety has been received at the interface.

The specification can contain or consist of a file which is in a file format with a predefined internal structure.

In other words, the individual data packets can be assembled in the module for analog measurement data logging to form the file in such a way that it has the file format described above and then this file can be written to the memory at the designated location.

The description above with reference to the module for analog measurement value logging, method for operating the module for analog measurement value logging, data processing system, computer program and computer-readable medium also applies mutatis mutandis to the method for writing the specification and vice versa.

The disclosure further relates to a method for determining a file with a predefined internal structure for processing a measurement variable which is received from a measurement transducer on a module for analog measurement value logging,

The method includes determining a piece of information that characterizes a relationship between the measurement variable and a measurement value of the measurement transducer, and storing the determined information at a predefined location in the file.

In other words, the file comprising the specification or characteristic curve, which is also referred to above as a sensor description, can be generated with an external tool and then be in the form of a binary file. In one example, this binary file can then be transferred to the module for analog measurement value logging via a CAN bus with SDOs (SDO standing for service data object for parametrizing object directory entries), for example as part of the method described above for writing the specification into the memory of the module for analog measurement value logging.

The determination of the information that characterizes the relationship between the measurement variable and the measurement value of the measurement transducer may comprise receiving a user input concerning the relationship between the measurement variable and the measurement value of the measurement transducer.

The determination of the information characterizing the relationship between the measurement variable and the measurement value of the measurement transducer comprises displaying an input screen, optionally on a display of a control system, a personal computer, a tablet and/or a smartphone, in which the user input concerning the relationship between the measurement variable and the measurement value of the measurement transducer can be entered at predefined points.

An input screen can be understood as a graphical user interface that contains fields in which values can be entered or selected by a user.

The graphical user interface or operator interface fulfills the technical task of making (application) software for generating the file with a predefined internal structure for processing a measurement variable to be created on a computer by a user by means of graphical symbols or control elements, also known as widgets. The problem is solved by allowing a user to reproduce information in the form of the input screen from a data sheet of any transducer under guidance, to identify information that characterizes the relationship between the measurement variable and the measurement value of the measurement transducer, and by entering the information into the graphical user interface to convert this information into the file format required by the module for analog measurement data logging. The user interface allows the user of the module for analog measurement value logging, e.g. a process engineer, to benefit from the technical effect of the universally applicable module for analog measurement value logging and thus serves the technical purpose of the software configuration of the module for analog measurement value logging.

As described above, the specification can comprise constants or coefficients together with a reference to a function stored in the software, in particular firmware, of the module for analog measurement value logging. It is conceivable that these coefficients are queried as numerical values by means of the user interface and, optionally, also which function it is. The numerical values can then be automatically converted into the file format required for the file using the method and stored in the file at the designated location. Based on the information as to the function on which the characteristic curve is based, a corresponding pointer or a corresponding piece of information as to which function stored in the firmware of the module for analog measurement value logging is to be called can be automatically stored in the file at the designated location in the required file format.

The information can be displayed in such a way that the user is shown by means of the input screen which information from a standard or a data sheet of a measurement transducer is required and where this should be entered in the input screen. In concrete terms, this can mean that a file containing x-th order coefficients for an (optionally non-linear) (sensor) characteristic curve and with a “description string” should be stored in the module for analog measurement value logging.

Depending on the number and type of the coefficients (e.g. for a spline function) and of the required function, a microprocessor of the module for analog measurement value logging can then calculate a measurement value (e.g. a temperature value in ° C.) on the basis of a measured analog value, e.g. using a numerical method.

It is also conceivable that the user simply enters interpolation points of the characteristic curve in the input screen and then a function, e.g. a spline function, is automatically determined on it. The file or byte structure can then also be generated from this in a fully automatic process.

Without knowledge of the structure of the data format on the part of the user, it is thus possible to generate the file fully automatically by means of the method, which the module for analog measurement value logging can then process. Therefore, a technical effect is achieved by the user interface, since this credibly supports the user by means of a constant and/or guided human-machine interaction in the execution of a technical task, in this case the creation of the (digital) file for processing measurement variables of a measurement transducer in a specific or required file format. The technical effect is achieved in a credible manner, since the support of the user in the execution of the technical task is objectively, reliably and causally linked to the display of the input screen or user interface and does not depend on subjective interests or preferences of the user.

The input screen can be part of a web application. A web application (also online application or, for short, a web app) is an application program based on the client-server model. Unlike traditional desktop applications, web applications are not installed locally on the user's machine. The data processing can be carried out at least partially on a remote web server. The results of the data processing are transferred to the user's local client computer (thin client). A web application is usually used via a web browser. Unlike desktop applications, web applications do not require a specific operating system on the user's machine. One optional advantage of the web application in an industrial context may be inter alia the fact that a user does not need to install software on their computer for this purpose and thus a potential security risk can be avoided.

The description above with reference to the module for analog measurement value logging, method for operating the module for analog measurement value logging, data processing system, computer program, computer-readable medium and method for writing the specification also applies mutatis mutandis to the method for determining the file and vice versa.

The disclosure further relates to a device for data processing having means for carrying out the method for determining the file and/or method for writing the specification, a computer program comprising instructions which, when the program is executed by a computer, cause said computer to carry out the method for determining the file and/or the method for writing the specification, and/or a computer-readable medium comprising instructions which, when the instructions are executed by a computer, cause said computer to carry out a method for writing the specification and/or the method for determining the file. The description above with reference to the module for analog measurement value logging, method for operating the module for analog measurement value logging, data processing system, computer program, computer-readable medium, method for writing the specification and method for determining the file also applies here mutatis mutandis.

Furthermore, the disclosure relates to a file for use in a module for analog measurement value logging, wherein the file has a predefined structure and contains information for processing a measurement variable, which can be received from a measurement transducer on the module for analog measurement value logging, at a predefined point in the file. The file may be or may have been determined using the method described above for determining the file. The description above with reference to the module for analog measurement value logging, method for operating the module for analog measurement value logging, data processing system, computer program, computer-readable medium, method for writing the specification and method for determining the file, also applies mutatis mutandis to the file for use in the module for analog measurement value logging.

The file thus comprises a data structure or a data format, wherein an intended technical use thereof is a determination of measurement values based on measurement variables in a module for analog measurement value logging, so that as a result of this intended technical use a technical effect is produced. The data structure defining the file is therefore functional data, i.e. the structure or format of the file has a technical function in a technical system, in this case the control of the operation of the device that processes the data. As a file comprising functional data, the file inherently reflects the corresponding technical features of the module for analog measurement value logging.

Furthermore, the disclosure relates to a computer-readable medium containing the file described above for use in the module for analog measurement value logging. The description above with reference to the module for analog measurement value logging, method for operating the module for analog measurement value logging, data processing system, computer program, computer-readable medium, method for writing the specification, method for determining the file and to the file for use in the module for analog measurement value logging, also applies here mutatis mutandis.

Unless otherwise defined, all technical and scientific terms used herein have the same meaning as generally understood by a person skilled in the art in the field to which this disclosure belongs. If there are multiple definitions for a term, the definitions in this description shall be definitive unless otherwise specified.

Wherever the terms “for example”, “such as”, “including” and the like are used, this shall be construed as if followed by the expression “and without limitation” unless expressly stated otherwise. Similarly, “an example”, “exemplary”, and the like are to be understood as non-restrictive or as non-exhaustive enumerations. The same applies to numerical values, i.e. for example “comprising two ports” is to be understood as “comprising at least two ports”.

The term “substantially” allows for deviations that do not adversely affect the intended purpose. Descriptive terms are to be understood to be modified by the term “substantially”, even if the term “substantially” is not explicitly mentioned.

The terms “comprising” and “including” and “having” and “incorporating” (and similarly “comprises”, “includes”, “has” or “with” and “incorporates”) and the like are used interchangeably and have the same meaning. In particular, each term is interpreted as an open or non-exhaustive term meaning “at least the following” and is interpreted in such a way that it does not exclude additional features, limitations, aspects, etc. For example, “a device having the components a, b and c” means that the device comprises at least the components a, b and c. Similarly, the wording “a method having the steps a, b and c” means that the method comprises at least the steps a, b and c.

Consequently, unless the context clearly or explicitly requires otherwise, the words “comprise”, “comprising” and the like in the description and in the claims are to be understood in an inclusive sense and not in an exclusive or exhaustive sense, i.e., “including, but not limited to”.

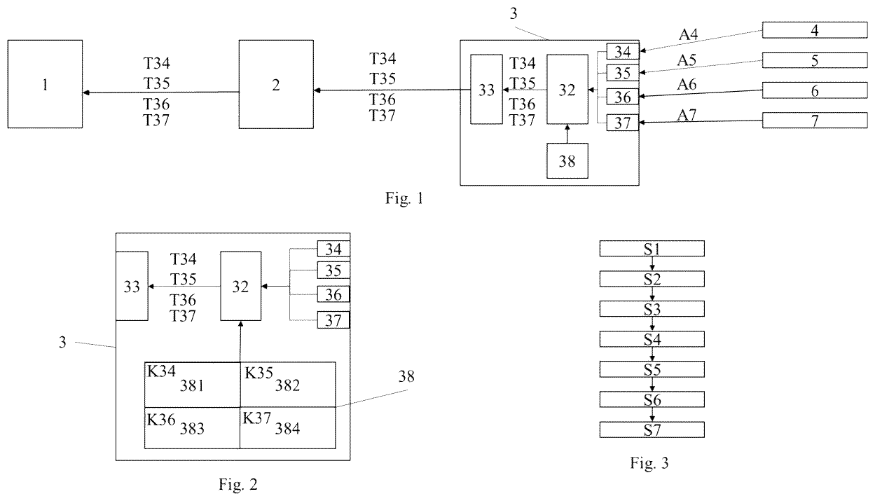

The system for data processing shown only schematically in FIG. 1 comprises a (process) control system 1, a gateway 2 connected to the control system 1, a module for analog measurement value logging connected via the gateway 2 to the control system 1 and four sensors 4-7, in the present case temperature sensors, which are each connected to the control system 1 via the module for analog measurement value logging 3 and the gateway 2.

The module for analog measurement value logging 3 comprises four channels or ports 34-37, each of these ports 34-37 being provided for one of the sensors 4-7 in each case or connected to one sensor 4-7 each, a (micro-) processor 32 connected to the ports 34-37, a non-volatile (flash) memory 38 connected to the processor 32 and an (output/input or I/O) interface 33, via which the module for analog measurement value logging 3 can communicate bidirectionally with the gateway 2.

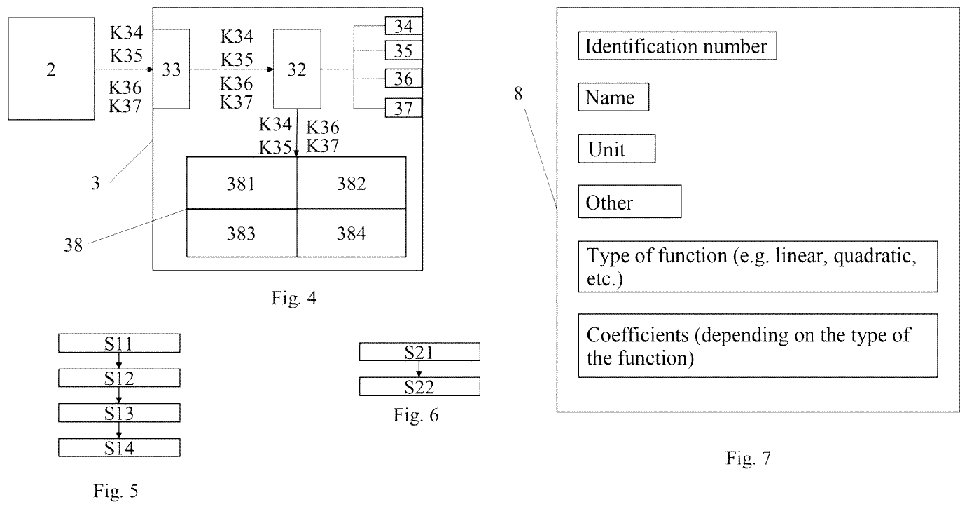

As can be seen in particular from FIG. 4, the memory 38 has four memory areas 381-384 substantially equal in size. Each of these four memory areas 381-384 is permanently assigned to one of the four ports 34-37 in a firmware of the module for analog measurement value logging 3 executed by the processor 32.

This allows the execution of a method for operating the data processing system, in particular for operating the module for analog measurement value logging 3, the flow diagram of which is shown in FIG. 3 and which is described in detail below.

In a first step S1 of the method, the first measurement transducer 4 measures or senses an environment variable, in the present case a temperature, and generates a corresponding electrical analog signal A4 as a function of its measurement transducer characteristic and outputs the generated analog signal A4 to the first port 34 of the module for analog measurement value logging 3.

In a second step S2 of the method, the information, i.e. the first analog signal A4, is received at the port 34 of the module for analog measurement value logging 3. The module for analog measurement value logging 3 then converts the first analog signal A4 generated in the first step S1 into a digital signal by means of an A/D converter (not shown) and outputs this digital signal to the processor 32.

The processor 32 executes a piece of software, in this case a firmware, which in the third step S3 of the method determines via which of the four ports 34-37 the digital signal corresponding to the first analog signal was received. It is conceivable that for this purpose the (digitized) measurement values of the ports 34-37 are processed consecutively by the firmware in an infinite loop and at a certain interval. For the port 34-37 which is currently being processed, the corresponding memory area 381-384 can then be indicated or referenced, e.g. via software pointers.

In the fourth step S4, based on the port 34-37 determined in the third step S3, the software then accesses the memory area 381-384 assigned to the determined port 34-37 in the software, in other words, the first memory area 381 is accessed in this case.

In each of the memory areas 381-384, a specification K34-K37 respectively is stored or saved, determining how the software has to process the digital signal which was obtained from the analog signal A4-A7 received via the respective port 34-37 in the manner described above.

Each of the specifications K34-K37 exists as a file with a file format having a predefined internal structure, wherein the software executed by the processor 32 is configured to process files that exist in this file format. Information for processing the measurement variable, here the digital signal which was obtained from the analog signal A34-A37 from the respective measurement transducer 34-37, is contained at a predefined location in the file. In addition, the file can contain an (individually assignable) identification number for the respective measurement transducer 34-37, an (individually assignable) name for the respective measurement transducer 34-37, an information about a unit of a measurement value (the so-called output information, e.g. ° C., K, Pa, etc.) of the respective measurement transducer 34-37, other information (see “Reserved in table”) and/or a CRC (code for so-called cyclic redundancy check).

The following is an example of a possible internal structure of the file format of the file, which can also be referred to as a sensor description, shown in detail in tabular form.

| Address | Size in bytes | Description |
|---|---|---|
| 0x000 | 4 | Identification number (32-bit number) |
| 0x004 | 16 | Name (string - 15 characters + 0-byte) |
| 0x014 | 2 | Unit (16-bit number) |
| 0x016 | 10 | Reserved |
| 0x020 | 36 | Sensor header |
| 0x044 | Up to 440 | Sensor body |
| 0x1FC | 3 | 32-bit CRC |

The identification number can serve as a unique identifier for each sensor description created.

The name can be a string to give the described sensor a readable name.

The unit can describe the unit of the process value or measurement value. The coding can be performed according to the HART specification.

The sensor header can contain all the information about the sensor that is necessary for logging the measurement and the linearization.

The sensor body can contain the polynomials and constants of the sensor.

The CRC can be a CRC over byte 0x000 up to and including byte 0x1FB, polynomial 0x04C11DB7, initial value 0xFFFFFF, 32-bit input reflection, output reflection, output XOR value 0xFFFFFFFF. In other words, the CRC can be a CRC over the entire content excluding the CRC itself.

While accessing the specific or dedicated memory area 381-384, in this case the first memory area 381, the software loads the specification K34-K37 stored therein, in this case the first specification K34, into the processor 32 to process the digital signal.

In a fifth step S5 of the method, the software executed by the processor 32 processes the digital signal according to the specification K34 loaded in the fourth step S4, and in doing so generates output information T34, the so-called measurement value, which comprises the measurement variable in a (file) format readable by the gateway 2. In other words, since the present example involves a temperature that is measured, the measurement value is the temperature in ° C. that corresponds to the measurement variable, i.e., for example, the voltage value contained in the analog signal.

In a sixth step S6 of the method, the output information T34 generated in the fifth step S5 is output to the gateway 2 via the interface 33 of the module for analog measurement value logging 3 using a first communication standard, e.g. in the case of a CAN interface the CANopen protocol.

In a seventh step S7 of the method, the output information T34 received by the gateway 2 in the sixth step S6 is output from the gateway to the control system 1 using a second communication standard, e.g. Ethernet-IP, Modbus-TCP, Profinet.

Above, the method for operating the module for analog measurement value logging 3 was explained in detail for the first sensor 4, wherein the method can be executed in identical manner for all sensors 4-7 (i.e. the second sensor outputs the analog signal A5 to the second port 35 and the module for analog measurement value logging processes this using the second specification K35 stored in the second memory area 382, etc.).

To establish the above-described state of the module for analog measurement value logging 3, the method described in detail below for writing the specifications K34-K37, already explained in detail above, can be carried out in the field, i.e. while the module for analog measurement value logging is operational, e.g. in a factory. The method for writing the specifications K34-K37 essentially comprises four steps S11-S14, as can be discerned from its schematic flowchart in FIG. 5, wherein this method will be described with the aid of the detailed view of the module for analog measurement value logging 3 in FIG. 4.

The specifications K34-K37 to be stored in the memory are in each case a file in the file format described above with the predefined internal structure.

In a first step S11 of the method, the port of the (in this case) four ports 34-37 of the module for analog measurement value logging, to which the specification is to be assigned, is determined.

In a second step S12 of the method, the specification is sent from the gateway 2 to the interface 33 of the module for analog measurement value logging, the specification being sent to the interface 33 in a plurality of data packets, here equal in size, of 64 bytes each. Therefore, a message bus from the gateway to the module for analog measurement value logging may be prevented from becoming overloaded or excessively loaded.

In a third step S13 of the method, the specification K34-K37 is received at the interface 33 of the module for analog measurement value logging 3.

In a fourth step S14 of the method, the specification is written to the memory area 381-384 of the memory 38 of the module for analog measurement value logging 3, which memory area is permanently assigned to the port 34-37 specified in the first step S1, wherein the specification is only written to this memory area 381-384 of the memory 38 once the entire specification has been received at the interface 33. It is conceivable that a temporary buffering of the data packets or parts thereof is carried out in another memory (e.g. the RAM) of the module for analog measurement value logging 3.

The following text describes in detail a method in which a user interaction, guided via an input screen in the form of a user interface 8 (see FIG. 7), is used to create the above-described file for the specification K34-K35 (i.e. for processing a measurement variable which can be received by a measurement transducer 4-7 on a module for analog measurement value logging 3). This method, as can be seen from the flowchart schematically illustrated in FIG. 6, essentially comprises two steps S21 and S22.

In a first step S21 of the method, information is determined that characterizes the relationship between the measurement variable and the measurement value of the respective measurement transducer 4-7. The relationship between the measurement variable and the measurement value of the respective measurement transducer, e.g. the polynomials of the characteristic curve, can be found, for example, in the standard or the data sheet of the measurement transducer. If only interpolation points and not polynomials are specified, one or more polynomials fitting the interpolation points can be determined in an intermediate step, e.g. using a polynomial regression procedure.

For this purpose, the input screen 8 shown in FIG. 7 is displayed to a user, for example by means of a web application, in which the user input regarding the relationship between the measurement variable and the measurement value of the measurement transducer can be entered at predefined locations. Furthermore, the other information required for the sensor description (see above, e.g. identification number, name, unit, . . . , other, etc.) is requested.

In more concrete terms, for a characteristic curve this can mean that the user first defines the type or form of the function using the graphical user interface 8. To do this, the user can be prompted to select from multiple menu items (not shown in FIG. 7). For example, the user is shown several images that represent different curve shapes for different functions (e.g. quadratic function, linear function, etc.). By selecting the function, e.g. by clicking on the appropriate image, the type of function can be specified by the user.

Then, the coefficients required to define the function (e.g. the slope of a linear function) can be queried using the user interface. Which coefficients are required for which function can be stored in the computer program underlying the user interface.

The user input received via the user interface 8 shown in FIG. 7, relating inter alia to the relationship between the measurement variable and the measurement value of the measurement transducer 4-7, is then converted into the corresponding file format (see sensor header and sensor body above) fully automatically. This means that the coefficients and the type of function (e.g. linear, quadratic, etc.) are then stored in the file (in the manner described above), in addition to the other information requested via the user interface 8. In other words, in a second step S22 of the method, the information determined is stored at the respectively predefined or designated location in the file.

If the user knows any (optionally non-linear) x-th order characteristic curve range (e.g. from a standard in which the coefficients are specified), the user can generate the file or the byte structure using the input screen and then this characteristic curve range can be programmed into the module for analog measurement value logging using the file.

### LIST OF REFERENCE CHARACTERS

1 control system
2 gateway
3 module for analog measurement value logging
32 processor
33 interface
34-37 ports for measurement transducers/sensors
38 memory, optionally flash
381-384 memory areas
4-7 measurement transducers/sensors
8 input screen/graphical user interface (GUI)
A4-A7 analog signal/measurement variable
T34-T37 digital signal/measurement value
K34-K37 specification for processing the digital signal, optionally function for converting the measurement variable into the measurement value
S1-S7 steps of the method for operating the module for analog measurement value logging
S11-S14 steps of the method for writing the specification into the module for analog measurement value logging
S21-S22 steps of the method for determining the specification

What is claimed is:

1. A module for analog measurement value logging, the module for analog measurement value logging comprising:
two ports, wherein for each port a measurement transducer can be connected to the module for analog measurement value logging, and
a memory,
wherein the memory comprises a dedicated memory area for each of the two ports, the dedicated memory area for each of the two ports being permanently assigned to the respective port.

2. The module for analog measurement value logging according to claim 1, wherein the module for analog measurement value logging is designed to determine via which of the two ports a piece of information, optionally a measurement variable, was received from the measurement transducer that can be connected to the respective port and based thereon, to access the dedicated memory area permanently assigned to the respective port.

3. The module for analog measurement value logging according to claim 2, wherein a specification for processing the received information is stored in the dedicated memory area that is accessed, and the module for analog measurement value logging is designed to access this specification.

4. The module for analog measurement value logging according to claim 3, wherein the module for analog measurement value logging is designed to process the received information, using the specification for processing the received information that was accessed, thereby generating output information.

5. The module for analog measurement value logging according to claim 4, further comprising an interface, wherein the module for analog measurement value logging is designed to output the generated output information via the interface to an external data processing device, optionally a gateway, which can be connected to the interface.

6. The module for analog measurement value logging according to claim 3, wherein the specification includes or consists of a file that is in a file format with a predefined internal structure.

7. The module for analog measurement value logging according to claim 6, wherein the module for analog measurement value logging is designed to process files that are in the file format with the predefined internal structure.

8. A data processing system, the data processing system comprising:
a control system,
a gateway connected to the control system, and
the module for analog measurement value logging according to claim 1, the module for analog measurement value logging being connected to the control system via the gateway.

9. A method for operating a module for analog measurement value logging, wherein the module for analog measurement value logging includes:
two ports, wherein for each port a measurement transducer can be connected to the module for analog measurement value logging, and
a memory,
the method comprising:
receiving information from one of the measurement transducers via one of the two ports,
determining via which of the two ports the information was received, and
accessing a dedicated memory area of the memory, which is permanently assigned to the port via which the information was received.

10. The method according to claim 9, wherein a specification for processing the received information is stored in the dedicated memory area which is accessed, and the method comprises accessing the specification.

11. The method according to claim 10, further comprising processing the received information, using the specification for processing the received information that was accessed, thereby generating output information.

12. The method according to claim 11, further comprising outputting the generated output information via an interface of the module for analog measurement value logging to an external data processing device connected to the interface.

13. The method according to claim 10, wherein the specification includes a file that is in a file format with a predefined internal structure.

14. The method according to claim 13, wherein the specification is accessed using a computer program executed by the module for analog measurement value logging, which is designed to process files that are in the file format with the predefined internal structure.

15. A non-transitory computer-readable medium comprising instructions which, when executed by a computer, cause the computer to carry out the method of claim 9.

16. A method for writing a specification for processing information in the memory of the module for analog measurement value logging according to claim 1, the method comprising:
defining the port of the two ports of the module for analog measurement value logging to which the specification is to be assigned, and
writing the specification to the dedicated memory area of the memory of the module for analog measurement value logging, which is permanently assigned to said port.

17. The method according to claim 16, further comprising:
sending the specification from an external data processing device, optionally a gateway, to an interface of the module for analog measurement value logging, and
receiving the specification at the interface of the module for analog measurement value logging,
wherein the specification is sent to the interface in a plurality of data packets, optionally of a same size.

18. The method according to claim 17, wherein the specification is only written to said dedicated memory area of the memory after the specification in its entirety has been received at the interface.

19. A method for determining a file with a predefined internal structure for processing a measurement variable which can be received from a measurement transducer on a module for analog measurement value logging, the method comprising:
determining information that characterizes a relationship between the measurement variable and a measurement value of the measurement transducer, and
storing the determined information at a predefined location in the file.

20. The method according to claim 19, wherein the determination of the information characterizing the relationship between the measurement variable and the measurement value of the measurement transducer includes:
receiving a user input concerning the relationship between the measurement variable and the measurement value of the measurement transducer, and
optionally, displaying an input screen, optionally on a display of a control system, a personal computer, a tablet and/or a smartphone, in which the user input concerning the relationship between the measurement variable and the measurement value of the measurement transducer can be entered at predefined points, wherein the input screen is optionally part of a web application.
